(19) United States
(12) Patent Application Publication
(10) Pub. No.: US 2024/0142405 A1
(43) Pub. Date: May 2, 2024

(54) SYSTEMS AND METHODS FOR MASS SENSING BASED ON INTEGRATED, FUNCTIONALIZED PIEZOELECTRIC RESONATORS

(71) Applicant: The Trustees of Columbia University in the City of New York, New York, NY (US)

(72) Inventors: Stylianos SIONTAS, New York, NY (US); Jose Antonio BAHAMONDE, New York, NY (US); Ioannis KYMISSIS, New York, NY (US); Peter R. KINGET, Summit, NJ (US); Sean MC SHERRY, Jersey City, NJ (US)

(21) Appl. No.: 18/408,545

(22) Filed: Jan. 9, 2024

Related U.S. Application Data
(63) Continuation-in-part of application No. PCT/US2022/035099, filed on Jun. 27, 2022.
(60) Provisional application No. 63/304,138, filed on Jan. 28, 2022.
(60) Provisional application No. 63/219,959, filed on Jul. 9, 2021.

(51) Int. Cl. G01N 29/02; G01N 29/24

(52) U.S. Cl. CPC G01N 29/022; G01N 29/2443; G01N 2291/014; G01N 2291/021

(57) ABSTRACT

Systems and methods for mass sensing based on integrated, functionalized piezoelectric resonators are described. A sensor includes a resonator coupled to an amplifier to form an oscillator. The resonator comprises a piezoelectric material and two or more electrodes, wherein the resonator has a first set of resonances, each with a set of electrical parameter values; a reflector underneath the resonator; a receptor coupled to the resonator, wherein the resonator has a second set of resonances, each with a set of different electrical parameter values when the target binds to the receptor; and a heating element and temperature sensor coupled to the receptor.

### CROSS-REFERENCE TO RELATED APPLICATION

This application is a Continuation-in-Part of International Application No. PCT/US22/35099, entitled “Systems and Methods for Mass Sensing Based on Integrated, Functionalized Piezoelectric Resonators,” filed on Jun. 27, 2022, which claims the benefit of priority to U.S. Provisional Application No. 63/219,959, entitled “Functionalized Piezoelectric Resonators for Mass Sensing,” filed on Jul. 9, 2021, and U.S. Provisional Application No. 63/304,138, entitled “Mass Sensors Based on Integrated, Functionalized Piezoelectric Resonators,” filed on Jan. 28, 2022, the disclosures of which are hereby incorporated by reference in their entirety.

### STATEMENT REGARDING FEDERALLY SPONSORED RESEARCH OR DEVELOPMENT

This invention was made with government support under Grant Nos. 2025955 and 2126910 awarded by the National Science Foundation. The government has certain rights in the invention.

### BACKGROUND

Gas sensors are utilized in a plethora of high-impact applications providing valuable data concerning the monitoring of hazardous leaks, threat detection, air quality, diagnosis of disease, metrology as well as agriculture and food storage. Successful applications of gas sensors rely on the ability of the sensors to provide continuous, real-time data while being interconnected and distributed densely at large scale to meet the requirements of Internet of Things (IoT) applications. Current gas sensing technologies struggle to meet the needs for pervasive monitoring in accordance with these IoT standards as they suffer from large size, high power consumption, high cost and lack of long term accuracy.

### SUMMARY

The present disclosure describes systems and methods for detecting a target. In some embodiments, a sensor includes a resonator coupled to an amplifier to form an oscillator. The resonator includes a piezoelectric material and two or more electrodes. The resonator has a first set of resonances, each with a set of electrical parameters. The sensor can also include a reflector underneath the resonator and a receptor coupled to the resonator. The resonator has a second set of resonances, each with a set of different electrical parameters when the target binds to the receptor. The difference between the values of the electrical parameters of the first set of resonances and the second set of resonances can indicate characteristics of the target that binds to the receptor. The sensor can further include a heating element and a temperature sensor coupled to the receptor. In some embodiments, the oscillator has a first resonant frequency. The oscillator has a second resonant frequency when the target binds to the receptor. The difference between the first and the second resonant frequencies can indicate characteristics of the target that binds to the receptor.

In some embodiments, the sensor includes an impedance matching layer on the surface of the resonator.

In some embodiments, the target includes molecules in the gaseous, vapor, liquid or solid phases (e.g., particulates).

In some embodiments, an application of an electric field between the two or more electrodes generates longitudinal and/or transverse (shear) and/or surface acoustic waves. In an embodiment, the waves may travel vertically through the thickness of the piezoelectric material to form a bulk acoustic wave (BAW) resonator.

In some embodiments, the reflector includes at least one of: a) a Bragg reflector (e.g., a stack of alternating layers of a high and a low acoustic impedance material comprising a Solidly Mounted Resonator (SMR)), or b) an air gap so that the resonator is suspended, comprising a Free Standing Resonator (FSR). In some embodiments, the air cavity of the Free Standing Resonator is sealed using a sealing layer to prohibit any exposure to the environment. In some embodiments, the sealing layer comprises oxides or nitrides materials.

In some embodiments, the impedance matching layer includes a number of individual layers with materials of different acoustic impedance values. In some embodiments, the impedance matching layer covers an area smaller, equal or larger than the top electrode, and allows the electrodes to be exposed for contacting.

In some embodiments, the piezoelectric material comprises Aluminum Scandium Nitride (AlScN), Aluminum Nitride (AlN) or Zinc Oxide (ZnO).

In some embodiments, the resonator is fabricated onto a complementary metal oxide semiconductor (CMOS) integrated circuit.

In some embodiments, the receptor covers area smaller, equal or larger than the top electrode (e.g., it can cover the entire resonator structure), and allows the electrodes to be exposed for contacting. In some embodiments, the receptor includes metal organic frameworks (MOFs). In some embodiments, the MOFs are deposited using a printing method.

In some embodiments, the receptor includes at least one of the following: porous materials, polymers, biomolecules, inorganic materials, self-assembled monolayers, or any combination thereof. In particular, the receptor can include, but is not limited to zeolites, molecular sieves, covalent organic frameworks, porous coordination polymers, metal organic materials, hybrid fluorinated ultra-microporous materials (e.g. SIF SIX, TIF SIX, SNIFSIX, NbOFFIVE-1-Ni), ultra-microporous materials, microporous materials, mesoporous materials (e.g., silicas, doped silicas, silica gels, silicates, doped silicates, titanium oxides, titanosilicates), amine and metal impregnated materials (e.g. amine or metal impregnated porous silica or cellulose), cellulose, carbonates (e.g., sodium bicarbonate, calcium carbonate, polycarbonates, fluorinated polycarbonates, metal alkali carbonates), hydroxides (e.g. sodium, lithium and potassium hydroxides), cage compounds, clathrates, inclusion compounds, graphite, activated carbon, carbon black, carbon molecular sieves, polymers (e.g. silicones, polymethylmethacrylate, polydimethylsiloxane, polyurethane-siloxane, polyurethane, polytetrafluoroethylene), conductive polymers, super absorbent polymers (e.g., sodium or potassium polyacrylate), mixed matrix membranes (e.g. metal organic framework impregnated polymers), nanoscale organic hybrid materials, electrospun polymer nanofibers, molecularly imprinted polymers, doped polymers (e.g., silicon doped polymers), polymer-grafted nanoparticles, composites (e.g. polymer composites, organic-inorganic composites, nanocomposites), electrospun composite nanofibers, electrospun inorganic nanofibers, moisture swing materials (e.g., ion exchange polymers, quaternized graphene oxide, silica), polymeric, ceramic and carbon-based membranes, organic supramolecular compounds (e.g. cryptophanes), self-assembled monolayers, ammonia borane, pyrrole, polysiloxane-tethered quaternary ammonium salt, bio-molecules (e.g., olfactory binding proteins, olfactory neuron receptors, peptides, antibodies, DNA and RNA strands (e.g., aptamers), sugars, lipids, lectins, proteins, enzymes, antibodies), small molecules, metal oxides, metal oxide nanostructures (e.g., titanium, copper, cerium and gold oxides), mixed metal oxides, nanoparticles, nanopowders, nanoparticles, nanowires, nanotubes, nanofibers, carbon nanotubes, 2-dimensional nanostructures (e.g., graphene, graphene oxide, molybdenum disulfide, nanosheets), inorganic films (e.g., silicon oxide, aluminum oxide, magnesium oxide, titanium oxide, poly-silicon and nitrides) or any combination thereof.

In some embodiments, the heating element includes a resistive heater (e.g., a micro-hotplate).

The present disclosure also describes a detection system comprising an array of sensors.

In some embodiments, a differential measurement of electrical parameters from multiple resonators of the array is performed. For example, the difference in frequency between resonators can be assessed using passive or active frequency mixing circuitry.

In some embodiments, frequency division circuitry is used to enable high precision and lower power measurements of resonant frequency signals.

### BRIEF DESCRIPTION OF THE FIGURES

For a more complete understanding of various embodiments of the disclosed subject matter, reference is now made to the following descriptions taken in connection with the accompanying drawings.

FIG. 1 shows a schematic of a solidly mounted resonator (SMR) functionalized with a receptor layer, according to some embodiments of the present disclosure.

FIG. 2 shows schematics of an SMR integrated on top of a CMOS circuit, according to some embodiments of the present disclosure.

FIG. 3A and FIG. 3B show schematics of two versions of a Free Standing Resonator (FSR) integrated on top of a CMOS circuit, according to some embodiments of the present disclosure.

FIG. 4 shows an array including N times M number of sensors (i.e. functionalized SMRs or FSRs) integrated onto a CMOS circuit, according to some embodiments of the present disclosure.

FIG. 5 shows a block diagram representing an array of oscillators in which a differential measurement is implemented via passive or active mixing circuitry, according to some embodiments of the present disclosure.

FIG. 6 is an example flow chart illustrating a method for detecting targets with an array of sensors (i.e. functionalized resonators), according to some embodiments of the present disclosure.

### DETAILED DESCRIPTION

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

The present disclosure describes a sensor that is based on CMOS integrated functionalized piezoelectric resonator arrays, allowing for an unparalleled combination of sensor detection performance (i.e., sensitivity and selectivity), size, power, and price. The ability to deliver a cost-effective and reliable gas sensor solution that is manufactured on established, high-volume processes is transformative in the IoT chemical sensing field.

Current gas sensing technologies are mature and span prices from $10 to north of $10,000. Competitive technologies that capture a major share of the market are optical methods such as infrared and photoionization and resistive methods such as metal oxide, catalytic and electrochemical. Even though these technologies are established, they suffer from inherent weaknesses such as the need for heating as well as complex optical components and power supplies leading to large size, weight, power, and cost (SWaPC). In particular, there is a tradeoff between detection accuracy (e.g., as quantified by a) sensitivity defined as the ability to detect small amounts of the target and b) selectivity defined as the ability to distinguish the target from confounders in order to minimize false positives) and SWaPC, namely sensors that exhibit high detection accuracy suffer from high SWaPC prohibiting their effective use in IoT applications. On the other hand, solutions that are cheaper and more compact do not possess the required detection accuracy necessary for high performance applications.

The present disclosure describes a sensing technology based on CMOS integrated functionalized piezoelectric resonator arrays that allows for significantly bridging that gap. Specifically, the present disclosure describes a gravimetric approach utilizing piezoelectric materials which detect the mass of targets when they adsorb to the sensor surface. Fabricating an array of these structures and coupling them with receptors that possess differential binding affinities to a class of targets, achieves selectivity and multi-target detection and identification capability. In particular, the direct integration of such arrays onto CMOS circuits can allow for up to 1000 times more compact size, lower power and lower cost while offering superior detection performance than currently employed technologies. A “receptor” can be also referred to as a “sensing material” or a “sorbent” including any material that possesses a binding affinity to a target. Furthermore, the parameter of “binding” includes surface sorption (sometimes also referred to as adsorption) and/or volume sorption (sometimes also referred to as absorption) that can be reversible or irreversible.

The present disclosure describes a piezoelectric resonator that can be used to implement a crystal oscillator circuit by coupling the resonator to an amplifier to counteract losses. In some embodiments, the resonator can be utilized as a gravimetric mass sensor. In some embodiments, the resonator can include a piezoelectric material and a plurality of electrodes.

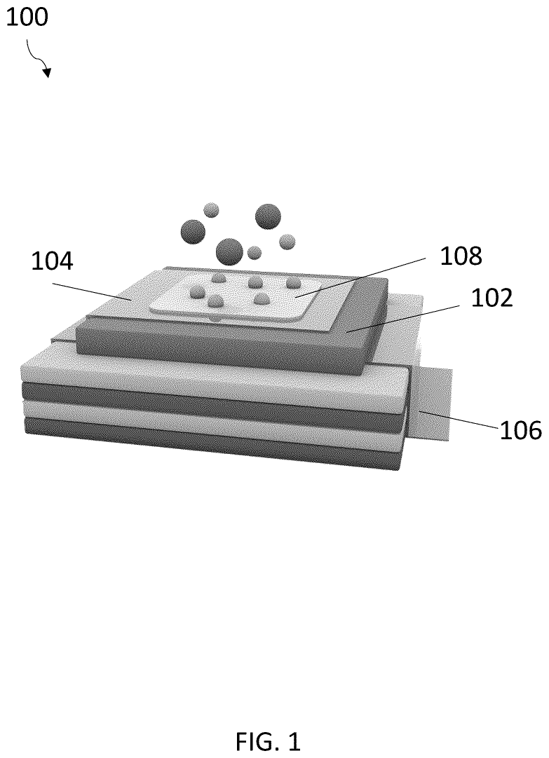

FIG. 1 shows schematics of a solidly mounted resonator (SMR) structure 100 functionalized with a receptor layer, according to some embodiments of the present disclosure. In some embodiments, the resonator includes a piezoelectric layer 102 that comprises zinc oxide (ZnO), aluminum nitride (AlN), or scandium doped aluminum nitride (AlScN). The application of an electric field between electrodes 104 and 106 in contact with the piezoelectric layer 102 can generate longitudinal and/or transverse (shear) and/or surface acoustic waves. In some embodiments, the electrodes 104 and 106 can comprise a variety of geometries and topologies. For example, the electrodes 104 and 106 can: a) be identical, orb) possess different shapes and sizes compared to each other. In some embodiments, the electrodes 104 and 106 can couple to the piezoelectric layer 102 in a variety of configurations. For example, the electrodes 104 and 106 can: a) sandwich the piezoelectric layer in a top/bottom configuration, b) be aligned or misaligned, or c) be placed on the same surface rather than sandwiching the piezoelectric layer 102 in a top/bottom configuration. In particular, the latter configuration can facilitate generation of shear and/or surface acoustic waves (e.g., including but not limited to Lamb, Love and Sezawa waves).

In some embodiments, the receptor layer 108 can be disposed on the surface of the resonator without an impedance matching layer. In some embodiments, an impedance matching layer can be introduced between the receptor layer 108 and the resonator for adjusting (e.g., enhancing) acoustic coupling. In some embodiments, the impedance match layer can include but is not limited to, oxide and nitride materials. The receptor can exhibit a binding affinity to the target. The receptor can cover area smaller, equal or larger than the electrodes (e.g., it can cover the entire resonator structure, however still allowing the electrodes to be exposed for contacting).

When target molecules (that can be in the gaseous, vapor, liquid or solid phase (e.g., particulates) selectively bind to the receptor, their added mass to the resonator structure can cause change in value of its resonances' electrical parameters (e.g., including but not limited to its S-parameters, impedance, resonant frequency, quality factor, and other equivalent circuit parameters such as motional capacitance, motional resistance, motional inductance and static capacitance.) This can result in a selective gravimetric sensor. The sorption and desorption of the target molecules via reversible mechanisms allow for multiple sensing cycles.

In some embodiments, the receptor material can include, but is not limited to, metal organic frameworks (MOFs). In some embodiments, the receptor comprises zeolites, molecular sieves, covalent organic frameworks, porous coordination polymers, metal organic materials, hybrid fluorinated ultra-microporous materials (e.g. SIF SIX, TIF SIX, SNIFSIX, NbOFFIVE-1-Ni), ultra-microporous materials, microporous materials, mesoporous materials (e.g., silicas, doped silicas, silica gels, silicates, doped silicates, titanium oxides, titanosilicates), amine and metal impregnated materials (e.g. amine or metal impregnated porous silica or cellulose), cellulose, carbonates (e.g., sodium bicarbonate, calcium carbonate, polycarbonates, fluorinated polycarbonates, metal alkali carbonates), hydroxides (e.g. sodium, lithium and potassium hydroxides), cage compounds, clathrates, inclusion compounds, graphite, activated carbon, carbon black, carbon molecular sieves, polymers (e.g. silicones, polymethylmethacrylate, polydimethylsiloxane, polyurethane-siloxane, polyurethane, polytetrafluoroethylene), conductive polymers, super absorbent polymers (e.g., sodium or potassium polyacrylate), mixed matrix membranes (e.g. metal organic framework impregnated polymers), nanoscale organic hybrid materials, electrospun polymer nanofibers, molecularly imprinted polymers, doped polymers (e.g., silicon doped polymers), polymer-grafted nanoparticles, composites (e.g. polymer composites, organic-inorganic composites, nanocomposites), electrospun composite nanofibers, electrospun inorganic nanofibers, moisture swing materials (e.g., ion exchange polymers, quaternized graphene oxide, silica), polymeric, ceramic and carbon-based membranes, organic supramolecular compounds (e.g. cryptophanes), self-assembled monolayers, ammonia borane, pyrrole, polysiloxane-tethered quaternary ammonium salt, bio-molecules (e.g., olfactory binding proteins, olfactory neuron receptors, peptides, antibodies, DNA and RNA strands (e.g., aptamers), sugars, lipids, lectins, proteins, enzymes, antibodies), small molecules, metal oxides, metal oxide nanostructures (e.g., titanium, copper, cerium and gold oxides), mixed metal oxides, nanoparticles, nanopowders, nanoparticles, nanowires, nanotubes, nanofibers, carbon nanotubes, 2-dimensional nanostructures (e.g., graphene, graphene oxide, molybdenum disulfide, nanosheets), inorganic films (e.g., silicon oxide, aluminum oxide, magnesium oxide, titanium oxide, poly-silicon and nitrides) or any combinations thereof.

In some embodiments, porous materials such as MOFs and zeolites can be used for the sensing of hydrocarbons, fluorinated hydrocarbons, hydro-fluoro-olefins as well as carbon dioxide and carbon monoxide. In some embodiments, polymers, nanostructures (e.g. nanoparticles, nanotubes, graphene), and SAMs can be used for the sensing of Volatile Organic Compounds (VOCs). In some embodiments, inorganic films (e.g., metal and semiconductor oxides) can be used for the sensing of reactive gasses (e.g., silanes, fluorine compounds, diborane). In some embodiments, bio-molecules (e.g., peptides, lipids, proteins, sugars, aptamers, olfactory neuron receptors) can be used for the sensing of other bio-molecules such as proteins, fatty acids, terpenes, viruses, antibodies and VOCs.

In some embodiments, the resonator structure 100 can be supported by an underlying Bragg reflector, e.g., a stack of alternating layers of high and low acoustic impedance materials for acoustic isolation from substrate, resulting in a Solidly Mounted Resonator (SMR).

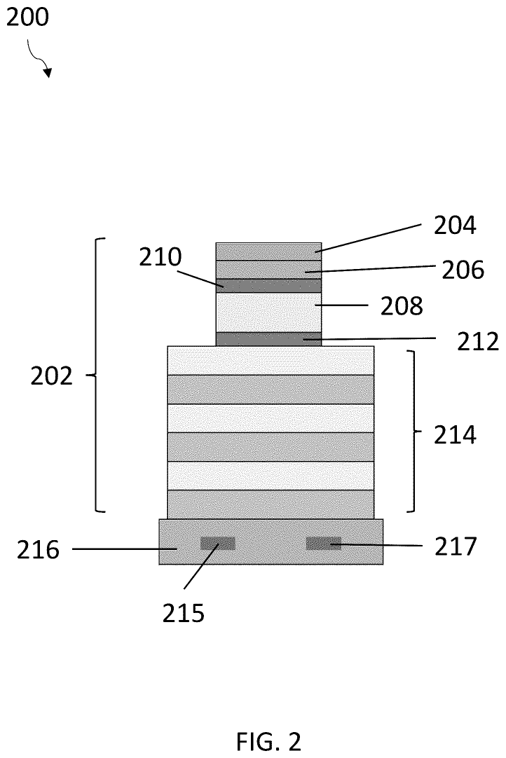

FIG. 2 shows schematics of a sensor 200 having an SMR 202 integrated with a CMOS circuit 216, according to some embodiments of the present disclosure. In some embodiments, the sensor 200 includes a receptor layer 204, an optional impedance matching layer 206, a piezoelectric layer 208, electrodes 210 and 212, and an acoustic reflector 214. In some embodiments, the acoustic reflector 214 includes a stack of alternating layers of high and low acoustic impedance materials, e.g., but not limited to, tungsten or molybdenum, and silicon oxide or silicon nitride, respectively. In some embodiments, the CMOS circuit 216 includes circuitry to implement a heating element 215 and a temperature sensor 217.

In some embodiments, the resonator structure can be suspended over an air cavity supported by electrodes of appropriate geometry and topology, resulting in a Free Standing Resonator (FSR).

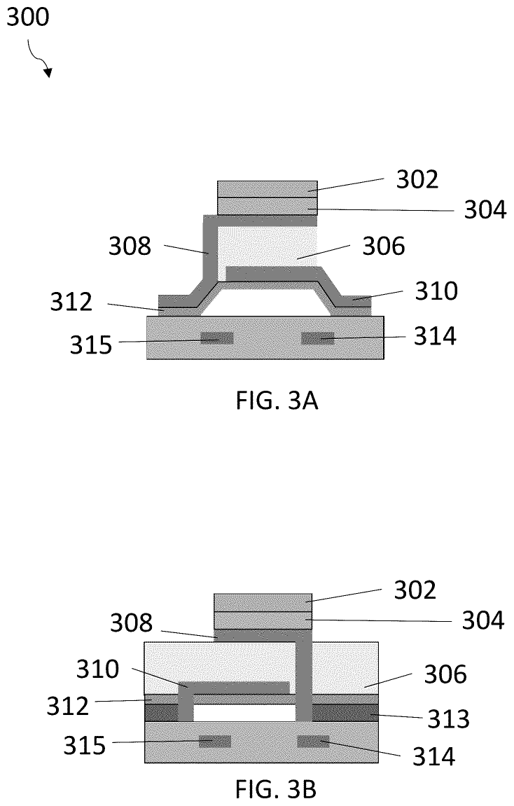

FIG. 3A and FIG. 3B show schematics of a sensor 300 having an FSR integrated on top of a CMOS circuit, according to some embodiments of the present disclosure. In some embodiments, the sensor 300 includes a receptor layer 302, an optional impedance matching layer 304, a piezoelectric layer 306, and electrodes 308 and 310. In some embodiments, the sensor 300 includes a sacrificial layer 313 for the implementation of the FSR air cavity. This can be part of the intrinsic CMOS circuit passivation (e.g. silicon dioxide) or can be an added layer on top of the CMOS circuit. In some embodiments, the CMOS circuit includes circuitry to implement a heating element 314 and a temperature sensor 315.

In some embodiments, the air cavity of the FSR can be appropriately sealed using a sealing layer 312 (e.g., but not limited to, an oxide or nitride material) to prohibit any exposure to the environment. In some embodiments, the Bragg reflector of FIG. 2 and air cavity of FIG. 3 can isolate/confine the acoustic wave in order to minimize losses into the underlying substrate with the aim of enhancing the quality factor of the oscillator circuit.

As shown in FIGS. 2 and 3, an optional impedance matching layer can be disposed on the surface of the resonator. This impedance matching layer can cover an area smaller, equal, or larger than the electrodes, however still allowing the electrodes to be exposed for contacting. In some embodiments, the impedance matching layer can include a number of individual layers comprising materials of appropriate acoustic impedance values. The impedance matching layer can be appropriately designed to enhance the sensitivity of the resonator, (e.g., to increase the ability to shift its resonance frequency as a result of a change in its mass) as well as to increase its quality factor, i.e., its ability to minimize acoustic wave losses. In some embodiments, the impedance matching layer can include an oxide or nitride material.

In some embodiments, the resonator (e.g., the SMR or the FSR) electrically coupled to an amplifier circuit (e.g., a transistor) constitutes an oscillator circuit. The resonator can have a set of resonances (e.g., including but not limited transverse longitudinal mode, transverse shear mode), each having a set of electrical parameters values. When mass (e.g., a target molecule) binds to the receptor, the resonator will shift to another set of resonances, each having a set of new electrical parameters values. This change of electrical resonance can be measured by appropriate circuitry (e.g., including but not limited to impedance analyzer, network analyzer, spectrum analyzer, frequency counter).

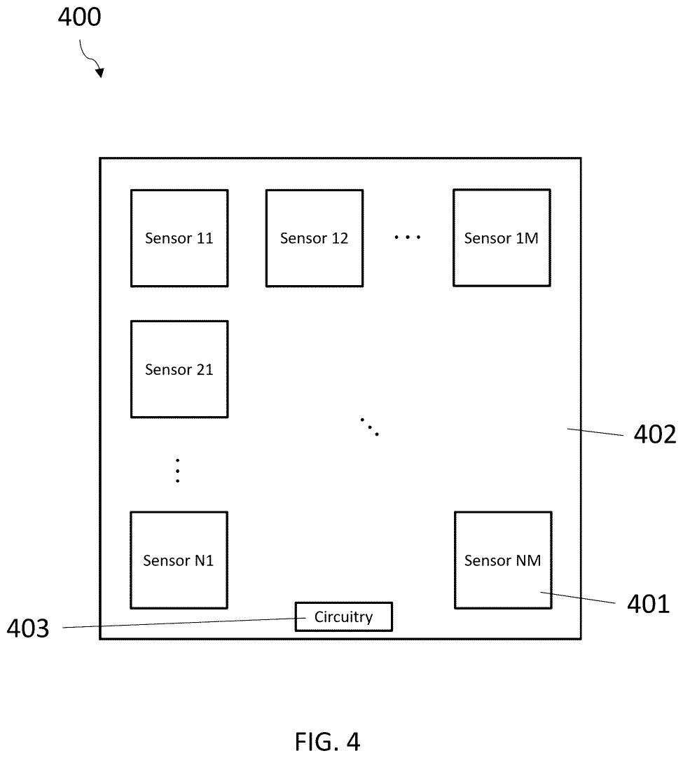

In some embodiments, the resonator is directly fabricated onto an underlying silicon Complementary Metal Oxide Semiconductor (CMOS) integrated circuit. In some embodiments, the CMOS circuit can include circuitry for coupling the resonator to an amplifier to counteract losses in order to implement an oscillator circuit (see FIG. 4, 403). In some embodiments, the CMOS circuit includes all electronic components to implement the detection system, e.g., including but not limited to the measurement of the resonant electrical parameters' values, their change in real time, signal processing, and signal readout (see FIG. 4, 403).

The present disclosure further describes an array of multiple sensors. FIG. 4 shows a schematic of an array 400 of N times M sensors (i.e. functionalized SMRs or FSRs) integrated onto a CMOS circuit 402, according to some embodiments of the present disclosure. In some embodiments, the CMOS circuit 402 can implement an oscillator by coupling an amplifier to the resonator. In some embodiments, the CMOS circuit 402 can differentially measure electrical parameters of the resonators' resonances. For example, the difference in frequency between resonators can be assessed using passive or active frequency mixing circuitry 403. In some embodiments, the CMOS circuit can implement signal division operations in order to measure with high precision and low power consumption using circuitry 403. In some embodiments, the CMOS circuit 402 can include an integrated resistive heating element (e.g., micro-hotplate) and a temperature sensor 403, which without limitation can be used to a) accelerate desorption of the targets to minimize sensor regeneration time and support multiple short sensing cycles, b) adjust sensor performance (e.g., sensitivity), and c) correct the effect of environmental factors (such as relative humidity and ambient temperature) on the sensor detection performance.

In some embodiments, the array can also relax the requirements for highly specific receptors in order to achieve selectivity. In particular, the array can enhance selectivity against environmental factors (e.g., presence of other molecules or temperature), allowing the implementation of an “electronic nose” where fingerprints of molecule mixtures can be obtained, offering multiple target detection and identification in the presence of noisy factors.

In particular, the sensor array gets exposed to a mixture of targets and temperature. Each sensor of the array has a set of resonances. Each resonance has a set of electrical parameters. Each electrical parameter value of each resonance of each sensor on the array will change differently when exposed to each of the various targets in the mixture. The sum of responses will lead to a cumulative change of each electrical parameter value, which is measured by appropriate circuitry. The composition of the target mixture can be inferred by previously performing a calibration of the sensor array by exposing it to predetermined mixture of targets and obtaining the cumulative responses of each electrical parameter of each sensor.

Specifically, when dealing with temperature as a confounder, apart from using receptor functionalized resonators as references, other circuitry can be used on the CMOS circuit, in order to achieve real time calibration and cancel its effect. In an embodiment, a crystal resonator (e.g. a Quartz Crystal Microbalance (QCM)) can be used to implement a phase-locked loop circuit where a tunable oscillator based on the resonator is adjusted in real time according to the reference signal from the QCM. Since temperature and mass loading events have identifiable temporal characteristics, a simple corrective algorithm can be employed to correct any drift due to temperature in real-time without erasing the presence of sensing events.

In some embodiments the array allows for differential measurement of the resonator electrical parameters in order to achieve real time correction against common noise (e.g., environmental confounders such as temperature and humidity) and signal drift and corrects the measurement baseline. In some embodiments the differential measurement can be implemented using passive or active mixer circuits. For example, the mixer can multiplex the oscillator output frequencies to obtain their difference and to down-convert them to the baseband frequency range for easy handling by other circuitry. In some embodiments, passive mixing can also assist in minimizing power consumption. In some embodiments, frequency division circuitry can be used for frequency down-conversion.

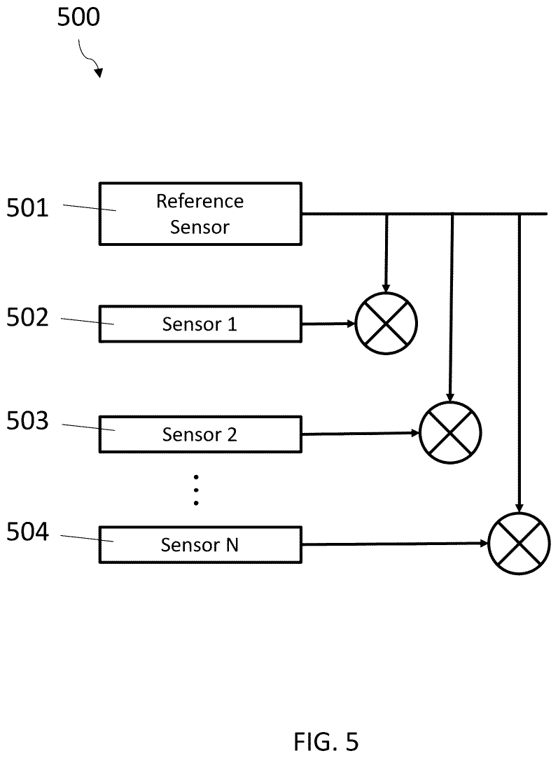

FIG. 5 shows a block diagram representing an array of oscillators where a differential measurement of the generated frequency signals from individual resonators is implemented using passive frequency mixer circuits, according to some embodiments of the present disclosure. Signals from oscillators 502, 503, and 504 are multiplexed with a signal from the reference oscillator 501 to obtain their frequency difference and to down-convert them to baseband frequency.

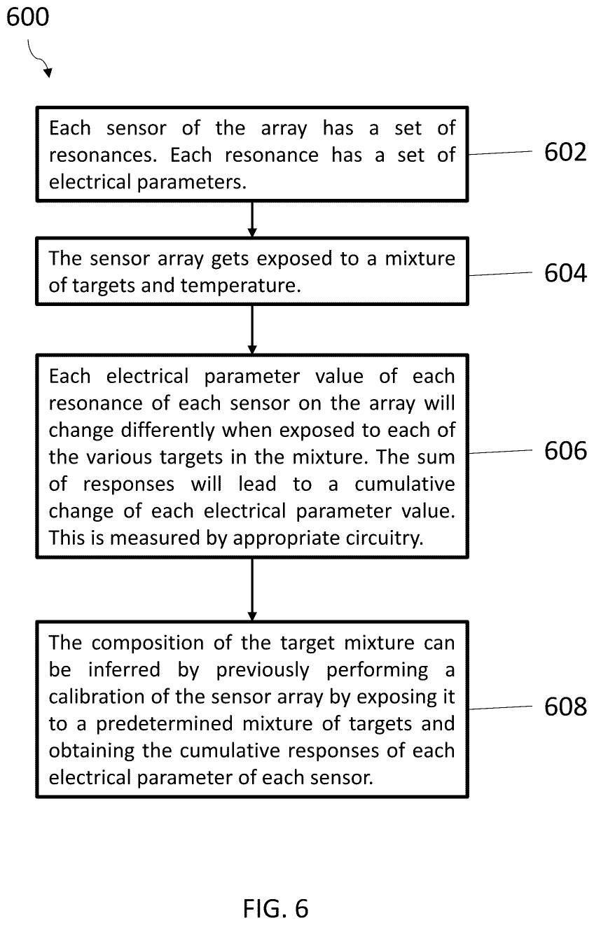

FIG. 6 illustrates an example method 600 for detecting molecules with an array of functionalized resonators, according to some embodiments of the present disclosure. At step 602, an array of sensors as described in the present disclosure is provided. Each sensor of the array has a set of resonances. Each resonance has a set of electrical parameters. Then, the sensor array is exposed to a mixture of molecule targets and temperature, as step 604. At step 606, after the sensor array is exposed, the value of each electrical parameter of each resonance of each sensor on the array will change differently when exposed to each of the various targets in the mixture. The sum of responses will lead to a cumulative change of each electrical parameter value, which is measured by appropriate circuitry. Then, at step 608, the composition of the target mixture can be inferred based on a previously performed calibration of the sensor array conducted by exposing the array to a predetermined mixture of targets and obtaining the cumulative responses of the values of each electrical parameter of each sensor.

The present disclosure also describes an integrated resistive heater (e.g., micro-hotplate) circuit embedded into the CMOS circuitry, which without limitation can be used to a) accelerate desorption of the targets to minimize sensor regeneration time and support multiple short sensing cycles, b) adjust sensor performance (e.g., sensitivity), and c) correct the effect of environmental factors (such as relative humidity and ambient temperature) on the sensor detection performance.

An example of calibrating out temperature as a confounder is to track the electrical parameters of two resonances of the same resonator so that the common effect to their change can be removed.

The present disclosure also describes that the receptor material can be disposed via a plurality of manufacturing methods. Examples include but are not limited to: a) top-down deposition methods such as drop casting, pneumatic printing, capillary spotting, ink jet printing, aerosol jet printing and spray coating, electro-spray deposition, electro-spinning, spin-coating, spray-drying, cold spraying; b) bottom-up utilizing methods such as gas/vapor phase deposition (e.g., Physical Vapor Deposition using patterning for selective deposition on each resonator of the array, Chemical Vapor Deposition using patterning to obtain a growth seed layer like a metal oxide for selective deposition on each resonator of the array), liquid phase deposition (e.g., dip-coating the entire substrate to achieve layer by layer growth, utilizing printing to implement layer-by-layer growth recipe where the precursors are printed directly onto the resonator so that the receptor grows in situ and there is no need for patterning as is the case with the dip coating method; c) spin coating; and d) a combination of liquid and vapor deposition e.g., spin coating, dip coating or printing precursor A and then exposing it to precursor B which is in vapor form, or vice versa.

In some embodiments, the confinement of the receptor onto the resonator surface can be further enhanced by functionalizing the surface of the top electrode via a patterning technique in order to apply a (hydrophilic) coating, i.e., a binding layer (e.g. polymer or self-assembled-monolayer) that can be deposited using a stamp (e.g. silicon, metal, polymer) to transfer it that will promote selective receptor adhesion on the resonator surface. This can be complemented by passivating the rest of the substrate with a hydrophobic coating (e.g. polymers) to create a hydrophilic pocket. What this achieves is that: a) when printing, the receptor will only stick to the functionalized area, promoting smaller diameter spots to be printed as they are more confined due to the push inwards by the surrounding hydrophobic surface and b) when using dip coating, a receptor can be selectively grown on each resonator of the array as the receptor solution will not bind to the hydrophobic passivation. Alternatively, a well can be created onto of the resonator in order to confine the receptor on top of the resonator. This can be achieved via: a) lithography, b) patterning a hydrophobic polymer using lithography or printing it directly into a well shape.

In some embodiments the receptor can be mixed with a binder material, for example, but not limited to polymers (e.g. PVDF, PVP, Pebax, HPMC, Teflon, Cytop, Nafion or other fluoropolymers) during the use of top-down deposition methods (e.g. one of the printing methods described above). In addition, a thin binder film (e.g. polymer, self-assembled-monolayer) can be deposited on the resonator before printing the receptor suspension on top of it.

The monolithic integration of the CMOS integrated receptor-functionalized resonator array can benefit from the use of full wafer processing which leads to low fabrication cost. The reduction of sensor size due to CMOS scaling can allow the fabrication of an array of multiple resonators on each chip which can then be functionalized with receptors that possess differential binding affinities to a class of target molecules to achieve selectivity and multi-target detection and identification capability. A substantial reduction in power consumption can be realized due to low operating voltages and reduction of parasitic elements. In addition, a significant reduction in noise can lead to high sensitivity, i.e., the ability to detect targets at low concentrations. This is in stark contrast to current gas sensing technologies which suffer from a combination of large size, high power consumption and high cost in order to achieve the same sensing performance.

This present disclosure describes high performance molecule sensors based on CMOS-integrated piezoelectric resonators functionalized with receptors allowing selective detection capabilities. The sensors with high sensitivity and selectivity can be at the same time capable of ultra-low power operation, allowing the use of energy harvesting (e.g., via solar power) or battery power, which is not possible with conventional approaches which suffer from a detection accuracy versus SWaPC tradeoff.

While exemplary embodiments of the invention has been particularly shown and described with reference to specific preferred embodiments, it should be understood by those skilled in the art that various changes in form and detail may be made therein without departing from the spirit and scope of the invention as defined by the appended claims.

1. A sensing apparatus, comprising:
a resonator, wherein the resonator comprises a piezoelectric material and two or more electrodes,
a reflector adjacent to the resonator; and
a receptor coupled to the resonator.

2. The sensing apparatus of claim 1, further comprising an amplifier coupled to the resonator to implement an oscillator, wherein the resonator has at least one first parameter value associated with an inherent characteristic of the piezoelectric material, and the resonator has at least one second parameter value when a molecule binds to the receptor, and wherein the difference between the first and the second parameter values is indicative of a type of the molecule.

3. The sensing apparatus of claim 1, further comprising a heating element coupled to the receptor.

4. The sensing apparatus of claim 1, further comprising an impedance matching layer between the receptor and the resonator.

5. The sensing apparatus of claim 1, wherein the molecule comprises a molecule in gaseous, vapor, liquid, or solid phases.

6. The sensing apparatus of claim 1, wherein an application of an electric field between the two or more electrodes generates a longitudinal and/or transverse and/or surface acoustic wave.

7. The sensing apparatus of claim 1, wherein the reflector comprises a Bragg reflector having a stack of alternating layers of high and low acoustic impedance materials.

8. The sensing apparatus of claim 1, wherein the resonator comprises a free-standing resonator, and wherein an air cavity of the free-standing resonator is sealed using a sealing layer.

9. The sensing apparatus of claim 8, wherein the sealing layer comprises oxide or nitride materials.

10. The sensing apparatus of claim 4, wherein the impedance matching layer comprises a plurality of materials of different acoustic impedance values (e.g., oxide or nitride materials).

11. The sensing apparatus of claim 10, wherein the impedance matching layer covers an area smaller, equal, or larger than one of the two or more electrodes.

12. The sensing apparatus of claim 1, wherein the piezoelectric material comprises Aluminum Scandium Nitride (AlScN), Aluminum Nitride (AlN), or Zinc Oxide (ZnO).

13. The sensing apparatus of claim 1, wherein the resonator is integrated with a complementary metal oxide semiconductor (CMOS) integrated circuit.

14. The sensing apparatus of claim 1, wherein the receptor covers an area smaller, equal, or larger than one of the two or more electrodes.

15. The sensing apparatus of claim 1, wherein the receptor comprises a metal organic framework (MOF).

16. The sensing apparatus of claim 15, wherein the MOF is selectively deposited using a top-down and/or bottom-up growth method utilizing printing, gas phase deposition, liquid phase deposition or combination thereof.

17. The sensing apparatus of claim 1, wherein the receptor comprises at least one of porous materials, polymers, self-assembled monolayers and biomolecules.

18. The sensing apparatus of claim 1, where the first and second parameter values comprise at least one of S-parameters, impedance, resonant frequency, quality factor, motional capacitance, motional resistance, motional inductance and static capacitance.

19. A detection system comprising an array of the sensing apparatus of claim 1.

20. The detection system of claim 19, wherein at least one of the resonators of the array has at least one first parameter value and at least one second parameter value,
wherein the at least one of the resonators of the array has at least one third parameter value and at least one fourth parameter value when a combination of molecules binds to the receptor coupled to the at least one of the resonators of the array, and
wherein the difference between the at least one first parameter value and the at least one third parameter value is indicative of a first type of the combination of molecules, and
wherein the difference between the at least one second parameter value and the at least one fourth parameter value is indicative of a second type of the combination of molecules.

21. A method for detecting a molecule, comprising:
coupling a resonator to an amplifier to form an oscillator, wherein the resonator comprises a piezoelectric material and two or more electrodes, wherein the resonator has at least one first parameter value of the piezoelectric material;
disposing a reflector adjacent to the resonator;
coupling a receptor to the resonator, wherein the resonator has at least one second parameter value when the molecule binds to the receptor,
determining a type of the molecule in response to a detection of a difference between the first parameter value and the second parameter value, wherein the difference between the first parameter value and the second parameter value is indicative of a type of the molecule.

22. The method of claim 21, further comprising disposing an impedance matching layer between the receptor and the resonator.

23. The method of claim 21, further comprising applying an electric field between the two or more electrodes to generate a longitudinal and/or transverse and/or surface acoustic wave.

24. The method of claim 21, further comprising heating the receptor.

25. The method of claim 21, wherein the piezoelectric material comprises Aluminum Scandium Nitride (AlScN), Aluminum nitride (AlN), or Zinc Oxide (ZnO).

26. The method of claim 21, wherein the resonator is fabricated onto a complementary metal oxide semiconductor (CMOS) integrated circuit.

27. The method of claim 21, wherein the receptor comprises a metal organic framework (MOF).

28. The method of claim 21, wherein the receptor is selectively deposited using a top-down and/or bottom-up growth technique utilizing printing, gas phase deposition, liquid phase deposition or combination thereof.

29. The method of claim 21, wherein the receptor comprises at least one of porous materials, polymers, self-assembled monolayers and biomolecules.

30. The method of claim 21, where the first and second parameter values comprise at least one of S-parameters, impedance, resonant frequency, quality factor, motional capacitance, motional resistance, and static capacitance.

31. The method of claim 21, further comprising performing a differential measurement of resonant frequency signals generated from multiple sensors using passive or active frequency mixing circuitry.

32. The method of claim 21, further comprising performing frequency division operations of resonant frequency signals generated from multiple sensors.

33. A method of manufacturing the sensing apparatus of claim 1, comprising applying a binding layer to the sensor surface using patterning techniques to promote selective receptor adhesion and enhance receptor adhesion.
